(19) United States
(12) Patent Application Publication
(10) Pub. No.: US 2026/0285613 A1
(43) Pub. Date: Sep. 24, 2026

(54) DEVICE AND METHOD FOR ROTATING PACKAGING CONTAINERS

(71) Applicant: BW Converting GmbH, Neuwied (DE)

(72) Inventors: Martin DENNERT, Brey (DE); Marc KÜNSTER, Koblenz (DE); Stephen SCHEU, Neuwied (DE)

(73) Assignee: BW Converting GmbH, Neuwied (DE)

(21) Appl. No.: 19/479,308

(22) PCT Filed: Apr. 25, 2024
(86) PCT No.: PCT/EP2024/061473

§ 371 Date: Oct. 27, 2025

(30) Foreign Application Priority Data
Apr. 27, 2023 (DE) 10 2023 110 834.4

(51) Int. Cl. B65G 47/244; B65G 17/00; B65G 17/32; B65G 17/46; B65G 47/84

(52) U.S. Cl. CPC B65G 47/244; B65G 17/002; B65G 17/323; B65G 17/46; B65G 47/843

(57) ABSTRACT

A device for rotating packaging containers (e.g., shipping bags) through a predetermined angle of rotation while being moved forward on a processing section. The shipping bag is fixed via suction cups on the turntable of a transport carriage, which is connected to a mechanically driven transport track that circumnavigates the device. When passing through the processing section, rotation of the shipping bag parallel to the transport track by an angle perpendicular to the transport direction during forward movement is achieved via a lever arm of the turntable being guided by a guide curve of a mechanical cam plate. Rotation of the shipping bag parallel to the transport track by an angle perpendicular to the transport direction is achieved during forward movement. After completion of rotation and the release of the shipping bag, the transport carriage travels through a return section and is rotated back to its initial angular position.

### CROSS-REFERENCE TO RELATED APPLICATION

This application is a national phase of International Application No. PCT/EP2024/061473, filed Apr. 25, 2024, which is hereby incorporated by reference in its entirety.

### FIELD

This disclosure relates to a device and method for turning packaging containers, in particular shipping bags.

### BACKGROUND

Devices for manufacturing packaging containers, in particular in the form of shipping bags, also known as shipping pouches or mailing bags, are known in the prior art. The essentially flat shipping bags are usually manufactured on a processing line in individual steps by folding and gluing at different processing stations. The processing stations are set up one after the other along a constant transport direction. Since not every processing station can accept the intermediate product in the same orientation, it is necessary to rotate the shipping bags between the various individual steps. The rotation is often performed at an angle of 90°, for example, to change from a longitudinal to a transverse orientation. This is the case, for example, between a cutting station, which cuts individual pieces from long material webs, and a folding station, which folds the individual pieces. In order to ensure a substantially continuous or uniformly timed feed of the intermediate products, the shipping bags should be rotated during the forward movement between the individual stations.

In terms of highly automatable and efficient production at high throughput rates, the reliable rotation of the shipping bags during forward movement is therefore particularly beneficial.

An objective of this disclosure is to reliably rotate mailing bags through a specified angle of rotation during forward movement at a high throughput rate. For this purpose, a suitable device and a method that can be carried out with it are to be specified.

### SUMMARY

This objective is solved by the subject matter of the independent claims. Advantageous further developments of the subject matter of the independent claims are indicated in the dependent claims. The wording of all claims is hereby incorporated by reference into the content of this description. The use of the singular does not exclude the plural, which also applies in the reverse sense, unless otherwise stated. The individual steps of the method are described in more detail below. The steps do not necessarily have to be carried out in the order specified, and the method to be described may also include further steps not mentioned.

With regard to the device, the objective is solved according to this disclosure by a device having the features of claim 1. Accordingly, a device is provided which rotates the packaging containers, in particular shipping bags, through a predetermined angle of rotation while the shipping bags are moved forward on a processing section, with a mechanical drive, wherein the mechanical drive drives a circulating transport track, and with a transport carriage which has at least two carriage axles and is mechanically connected to the transport track.

Furthermore, the device has a turntable, wherein the turntable is rotatably arranged on the transport carriage. Furthermore, the device has a suction device, wherein the suction device is designed to fix the shipping bag on the turntable, as well as means for supplying negative pressure, wherein the means for supplying negative pressure are designed to supply the suction device with negative pressure. The device also has a processing section, whereby the shipping bag fixed on the turntable is moved in the transport direction on the processing section and rotated in the process. The device also has a return section, whereby the turntables are moved in the return section in the opposite direction to the transport direction and rotated back to the initial angular position in the process.

In addition, the device has a mechanical cam plate, wherein the mechanical cam plate has a guide cam and wherein the turntable is guided by the guide cam of the mechanical cam plate. The mechanical cam plate is designed to cause a rotary movement of the turntable in the specified direction of rotation when passing through the processing section. The mechanical cam plate is further designed to cause the turntable to rotate back to its initial angular position when passing through the return path, whereby the rotation of the mailing bag during passage through the processing path and the return path takes place parallel to the transport path about an axis of rotation perpendicular to the transport direction.

The axis of rotation is preferably located in a central area close to the center of gravity of the surface of the shipping bag that rests on the turntable, so that ideally no realignment or centering is required after rotation. Since the rotation takes place during movement in the transport direction, the axis of rotation also moves in the transport direction during rotation with the shipping bag. The use of transport carriages with at least two carriage axles minimizes the tilting movements of the transport carriage during entry and exit.

The rotation is preferably 90° in order to change rectangular shipping bags from a longitudinal to a transverse orientation. However, other angles may also be advantageous for non-rectangular formats. The rotation can be performed at any other angle and from any orientation, both clockwise and counterclockwise.

If several turntables are arranged at suitable intervals on the conveyor belt, continuous transport of the mailing envelopes along the processing line is ensured. A toothed belt drive with two toothed belts is preferred as the mechanical drive, although chain drives or toothed belt drives with a different number of toothed belts would also be conceivable.

Supplying negative pressure to the suction cups can provide a permanent or only sporadic supply, whereby the strength and duration of the fixation can be specifically influenced in combination with a corresponding control. The use of suction cups eliminates complex mechanics below the conveyor belt and at the same time facilitates accessibility, especially from above. The shipping bag can thus be reliably and quickly fixed to the turntable and, if necessary, the fixation can be released again in the same way. This improves reliability and increases the speed of transfer from one processing station to the next. Compensating for different product thicknesses is also simplified, as the nature of the underside is primarily decisive for fixation via negative pressure, and the product thickness plays only a minor role. Reliable fixation in conjunction with the repeatable rotary movement, which is achieved by the interaction of the turntable and the mechanical cam plate, also simplifies the rotation of soft products or makes it possible in the first place. In addition, it may be provided that the shipping bag is fixed on the turntable by a hold-down device acting from above, possibly also from the side or from below.

If the device has a start-up section before the beginning of the processing section as seen in the direction of transport and an exit section after the end of the processing section as seen in the direction of transport, and if the start-up and exit sections are arranged in such a way that the end facing away from the processing section is at a lower height than the end facing the processing section, the angle at which the transport carriage emerges is reduced. This minimizes tilting movements of the transport carriage and reduces the relative speed of the transport carriage in relation to the shipping bag, which minimizes wear on the suction cups and ensures that the suction cups do not lift the shipping bag during transfer. This would be less accurate and more prone to errors.

If the transport carriages preferably have two carriage axles, this prevents the outer suction cups from tilting over the transport track. If the preferably two carriage axles of the transport carriage are connected in the transport direction via preferably two linear joints or via two sliding-mounted rigid axles in such a way that the distance between the carriage axles, the so-called guide distance, is variable, the difference in travel between the transport path and the transport carriage can be compensated for, in particular at deflection points. Since the transport path describes an arc at the concentric deflection points between the processing section and the return section, but the transport carriage describes a chord, there is a distance difference between the two. For reliable and uniform operation, it is particularly advantageous to compensate for this difference in distance by means of a variable guide distance using linear joints or sliding rigid axes.

If the transport carriage is equipped with a lever arm, preferably with several cam rollers that can be guided along the guide curve of the mechanical cam plate, the reliability of the guide is increased and the rotary movement of the turntable is initiated in a particularly reliable and efficient manner.

If the guide curve is designed in such a way that at least one cam follower on each of the two outer walls is in contact with the guide curve at the same time, i.e., the guidance is circumferential, the repeat accuracy of the movement effected on the lever arm is increased by this circumferential guidance. A combination of circumferential guidance and internal guidance is particularly preferred, whereby a cam follower rests against the guide curve on both outer walls and on at least one inner wall at the same time. However, pure internal or external guidance and combinations of the guidance types mentioned here are also conceivable.

If the angle of rotation corresponds to the angle enclosed by two adjacent sides of the shipping bag, a variety of different shipping bag formats can be rotated without having to adjust or even replace the mechanical cam plate.

If the device has an upper guide and the upper guide has a surface parallel to the processing path, which is positioned in such a way that a shipping bag moving underneath it comes into contact with the parallel surface as soon as the shipping bag bulges, excessive deformation of the shipping bags is prevented, which would make it difficult to rotate the shipping bag safely.

In a preferred embodiment, the suction cups are supplied with negative pressure via a toothed belt with a flattened area in which suction holes are located and vacuum cams on the carriage axles of the transport carriage. This is done from a vacuum source connected to at least one control valve via a vacuum rail, wherein the vacuum rail is provided with at least one preferably slot-shaped supply bore. The supply bore is connected to the control valve. The vacuum rail is preferably arranged below the toothed belt. During operation, the toothed belt is preferably guided tightly over the vacuum rail so that the suction holes are at least temporarily located above the supply bore of the vacuum rail.

Starting from the vacuum source, a continuous air channel is formed via the control valve, the supply hole in the vacuum rail, and the suction holes in the flattened part of the toothed belt when the suction hole is located above the supply hole. At this moment, a continuous air channel is created between the stationary part of the device (vacuum rail, etc.) and the linearly moving subsystem (toothed belt, transport carriage, etc.).

This air channel extends further through a passage in the vacuum cam on a carriage axle, which is preferably designed as a hollow shaft, through the carriage axle itself, to a hollow cylinder in the turntable, which is located in the center of the turntable and aligned parallel to its axis of rotation. The hollow cylinder in turn has several recesses. These recesses are arranged circumferentially in such a way that, regardless of the orientation of the turntable, there is a continuous connection between the hollow cylinder of the turntable and the hollow carriage axis at all times. Finally, the individual suction cups are connected to the hollow cylinder itself via their own air ducts. If a suction hole is located above a supply hole, the resulting air duct connects the stationary part of the device to the linearly moving subsystem via the vacuum cam and, via the recesses in the hollow cylinder, connects the linearly moving subsystem to the rotating suction cups. In practice, the pressure level at the suction cups covered with paper is preferably around 200-300 mbar. Lower or higher pressures are also possible. The leakage volume flow at the contact between the toothed belt and the vacuum rail, which is created by this design, also cools the toothed belt.

By positioning the supply holes and valve control appropriately, the vacuum supply can be specifically influenced at any point along the processing line. This allows the fixing of the shipping bag during processing to be influenced in a variable, precise, and reliable manner.

The objection is also solved according to this disclosure by a method with the features of claim 10, according to which the shipping bag is first fixed on the turntable of a transport carriage via vacuum, then the transport carriage is moved through a circulating processing section and the shipping bag is rotated during passage parallel to the transport path by a predetermined angle of rotation about an axis of rotation perpendicular to the transport direction, and the turntable is rotated back to its initial angular position when passing through a return section.

Incidentally, the features and advantages relating to the device can be transferred accordingly to the method, and vice versa, so that further repetitions can be dispensed with at this point.

Further details and features are apparent from the following description of a preferred embodiment in conjunction with the figures. Here, the respective features may be realized individually or in combination with one another. The possibilities for solving the objective are not limited to the embodiment. For example, range specifications always include all intermediate values (not mentioned) and all conceivable subintervals.

### BRIEF DESCRIPTION OF THE DRAWINGS

The embodiment is shown schematically in the figures. Identical reference numbers in the individual figures denote identical elements or elements with the same function or corresponding functions. In detail, it is shown:

FIG. 1 is a view from above at an angle of the device according to this disclosure for turning packaging containers;

FIG. 2 is a view from above at an angle of a transport carriage of the device from FIG. 1;

FIG. 3 is a top view of the processing section of the device shown in FIG. 1;

FIG. 4 is a detailed view of the cross-section of the processing section of the device from FIG. 1 relating to the start-up and run-out sections;

FIG. 5 is a detailed view of the cross-section of the device from FIG. 1 relating to the guide of the turntable, and

FIG. 6 is a detailed view from above at an angle of the device from FIG. 1 relating to the vacuum supply to the suction cups.

### DETAILED DESCRIPTION

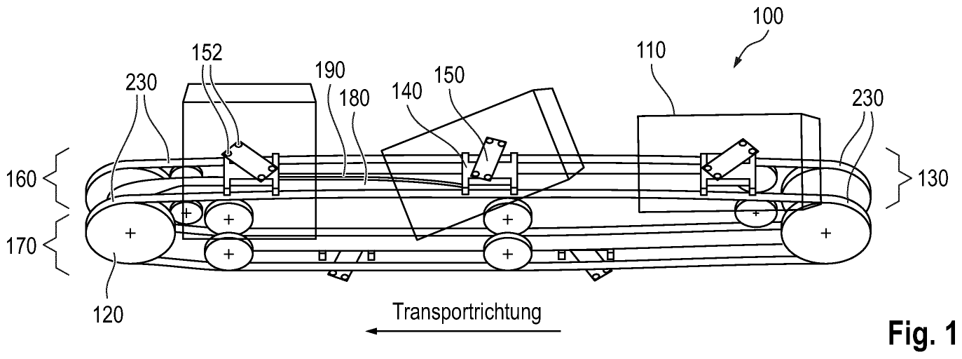

FIG. 1 shows a device 100 according to the invention for turning shipping bags 110. The device 100 has a mechanical drive 120 which drives a circulating transport track 130 via two toothed belts 230. The transport track 130 (not explicitly labeled in FIG. 1) is formed by the toothed belts 230 and guided over two deflection rollers. The transport track 130 essentially corresponds to the area enclosed by the toothed belts, but may extend beyond the area enclosed by the toothed belts. The transport carriages 140 are mechanically connected to the transport track 130, more precisely to the toothed belts 230, and are moved around the device 100 on the transport track 130. Turntables 150 are rotatably arranged on the upper side of the transport carriages 140. The device 100 also has suction cups 152 which fix the shipping bag 110 on the turntable 150 (means for supplying negative pressure 200 not shown in FIG. 1). On the upper side of the device 100, the transport track 130 forms a processing section 160, preferably in a horizontal position.

The transport carriages 140 are moved within the processing section 160 in the transport direction (here in the example from right to left), whereby the processing section 160 is aligned along the longitudinal direction of the device 100, preferably in a horizontal position. A return section 170 is formed on the underside of the device 100 by the transport track 130. The transport carriages 140 are moved within the return section 170 in the opposite direction to the transport direction, with the return section 170 being aligned along the longitudinal direction of the device 100, preferably in a horizontal position. A mechanical cam plate 180 with a guide cam 190 is arranged below the transport track 130. The mechanical cam plate 180 is preferably designed to be circumferential and positioned below the transport track 130. The guide curve 190 is preferably designed to be uninterrupted. It is also conceivable that the guide curve 190 is not designed as a continuous body over the entire processing section 160, but has interruptions.

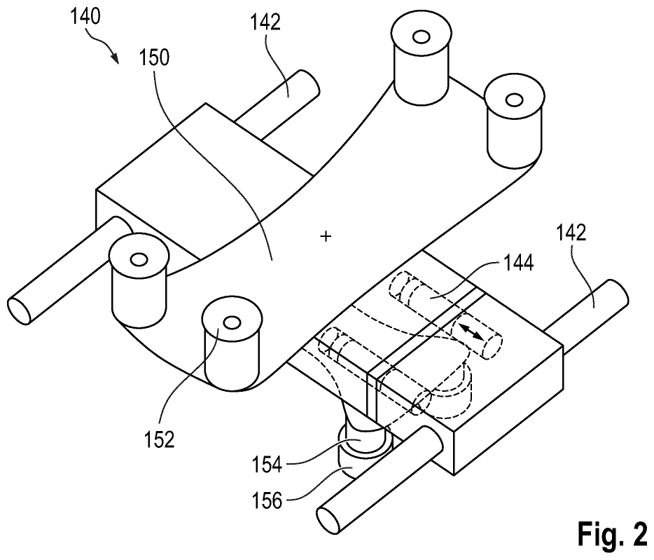

The turntables 150 are guided through the guide curve 190 as they pass through the transport track 130, preferably with the aid of cam rollers (see FIG. 2). Here, the translational movement of the transport carriages 140 is converted into a rotational movement of the turntables 150. When passing through the processing section 160, the turntables 150 and the shipping bag 110 fixed on the turntable 150 are thereby rotated in a predetermined direction of rotation and through a predetermined angle of rotation. When passing through the return section 170, the turntables 150 are rotated back to their initial angular position. The rotation takes place parallel to the transport track 130 about an axis of rotation perpendicular to the transport direction. The axis of rotation is preferably located in a central area near the center of gravity of the surface of the shipping bag 110 that rests on the turntable 150.

The start, end, direction, circumference, and timing of the respective rotational movement are determined by the interaction of the turntable 150 with the course of the guide curve 190. In this way, the rotation of the shipping bag 110 on the processing section 160 can be individually adjusted. Due to the circular design of the transport track 130 and the mechanical cam plate 180, the turntables 150 are ready to receive the next shipping bag 110 on the return section 170 after returning to their initial angular position. In this way, the rotation of the shipping bag 110 can be carried out with high repeat accuracy and a high throughput rate.

FIG. 2 shows a transport carriage 140 of the device 100. The turntable 150 is rotatably mounted on the top side of the transport carriage 140. The turntable 150 is preferably connected to a lever arm 154, which preferably has two cam rollers 156. The cam rollers 156 are attached to the two outermost corners of the lever arm 154, which are furthest away from the axis of rotation of the turntable 150. The cam rollers 156 have a fixed distance between them. In the individual sections, particularly those intended to cause the shipping bag to rotate, the guide curve 190 is adapted in its extension orthogonal to the transport direction to the distance between the cam rollers 156 and the respective angular position. The cam rollers 156 are at least temporarily in contact with opposite walls of the guide curve 190 at the same time and can roll along them. The extension of the guide curve 190 orthogonal to the transport direction is therefore not constant. The individual cam rollers 156 can be designed, for example, as eccentric rollers or as fixed rollers. The use of eccentric rollers makes it possible to position the outer surface of the corresponding cam roller 156 specifically against the surface of the inner or outer wall of the guide curve 190. In this way, coarser manufacturing tolerances, e.g., in the guide curve 190, are compensated for. The turntable 150 also has four suction cups 152, which fix the shipping bag 110 (not shown in FIG. 2) on the turntable 150 by applying negative pressure. The suction cups 152 are arranged with their suction surface facing upwards on the top of the transport carriage 140 in a circle whose center lies on the axis of rotation and whose diameter is smaller than or equal to the distance between the carriage axes 142. The suction cups 152 are arranged in such a way that a rectangle with sides of different lengths is formed by the suction cups 152, whereby the short sides of the rectangle are essentially shorter than the long sides of the rectangle. During operation, the center of the rectangle is ideally located near the center of gravity of the surface of the shipping bag 110 (not shown in FIG. 2) that rests on the turntable 150.

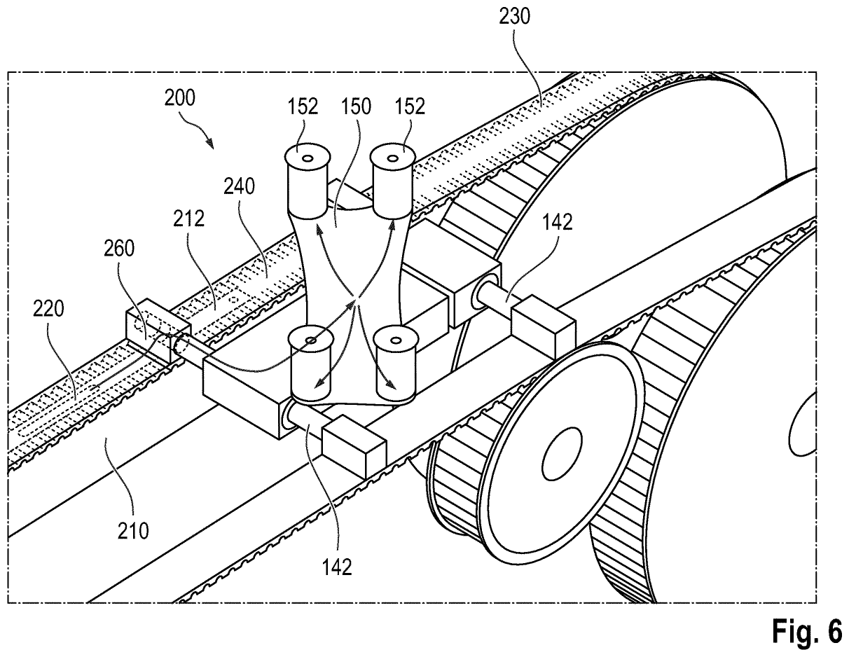

The carriage axles 142 of the transport carriage 140 are arranged parallel to each other at opposite ends of the transport carriage 140 and are each mechanically connected to both toothed belts 230. The carriage axles 142 are preferably designed as rotatably mounted hollow shafts (see FIG. 6). The turntable 150 is rotatably mounted on the surface between the carriage axles 142. The carriage axles 142 are preferably connected by a linear joint 144, whereby the linear joint 144 can be implemented, for example, by a spring. This makes the distance between the carriage axes 142, the so-called guide distance, variable. When passing through the transport track 130, the rear carriage part is pulled apart or pulled together at the deflections, i.e., the sections between the processing section 160 and the return section 170. Since the transport track 130 describes an arc at the concentric deflection points between the processing section 160 and the return section 170, but the transport carriage 140 describes a chord, there is a difference in distance between the two. If this difference in distance is not compensated for, this can lead, for example, to a break in the connection between the carriage axle 142 and the transport track 130. The variable guide distance provided by the linear joint 142 makes it possible to compensate for this difference in distance. In order to achieve a comparable effect, a design with a connection between the carriage axes 142 via a rigid axis that is mounted in a sliding manner, for example in a cam that connects the carriage axes 142 to the transport track 130, is also conceivable.

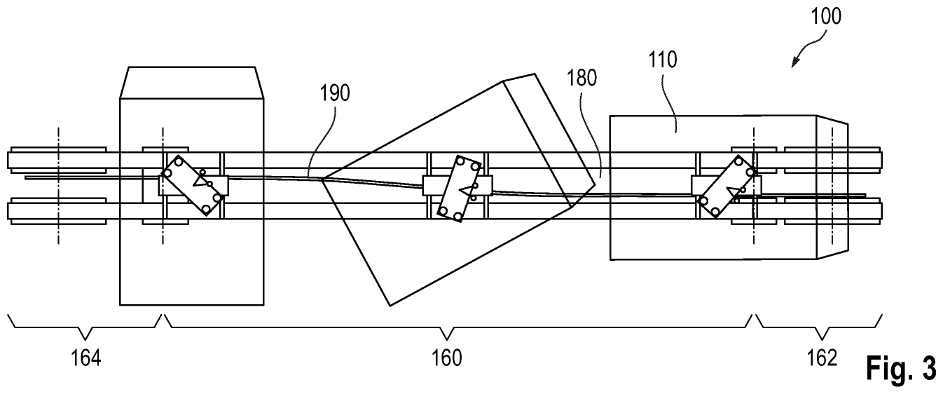

FIG. 3 shows the processing section 160 of the device 100. The start-up section 162 is located before the beginning of the processing section 160, viewed in the transport direction (here in the example from right to left), and the exit section 164 is located after the end of the processing section 160. In relation to a device for manufacturing packaging containers, the start-up section 162 serves to transfer the intermediate product from a previous processing station, and the exit section 164 serves to transfer it to a subsequent processing station.

The mechanical cam plate 180 has a guide cam 190 with a preferred curve that causes the shipping bag 110 to rotate 90° counterclockwise as it passes through the processing section 160. The shipping bag 110 is aligned parallel to the transport direction at the beginning of the processing section 160 and is rotated until it is aligned perpendicular to the transport direction.

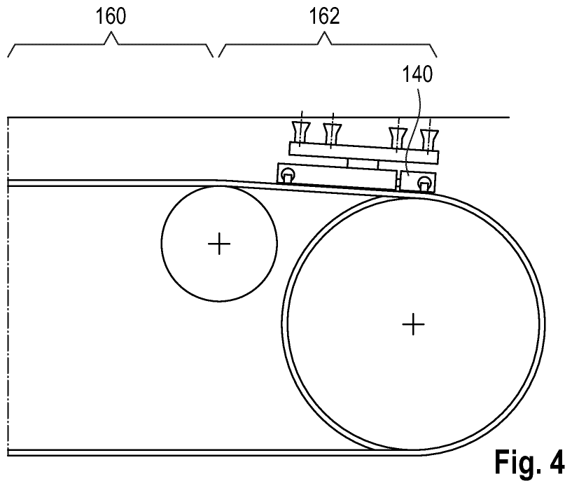

FIG. 4 shows the start-up section 162 of the device 100. The start-up section 162 is inclined relative to the processing section 160, which is achieved by additional deflection or guide rollers, whereby the end facing away from the processing section 160 is at a lower height than the end facing the processing section 160. When traveling through the approach section 162 in the transport direction (here in the example from right to left), the trailing end of the transport carriage 140 in the transport direction is initially below the level of the leading end. Only after traveling through the start-up section 162 are both ends at the same level. This “emergence” of the transport carriage 140 at a flat angle minimizes the relative speed of the transport carriage 140 with respect to the shipping bag 110 perpendicular to the transport direction. The transport carriage 140 is moved gently toward the shipping bag 110, preventing the suction cups 152 (not shown in FIG. 4) from hitting the shipping bag 110.

The exit section 164 (not shown in FIG. 4) is inclined relative to the processing section 160 in the same way as the approach section, so that the end facing away from the processing section 160 is at a lower height than the end facing the processing section 160.

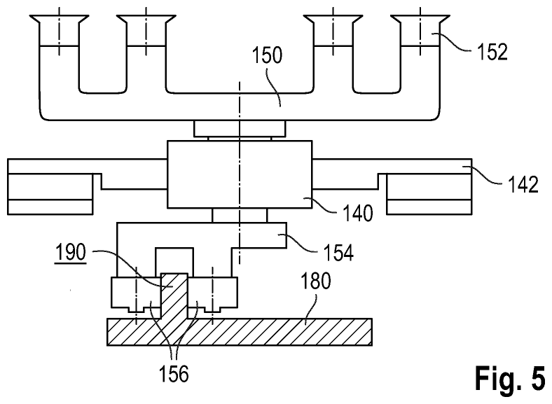

FIG. 5 shows the guide for the turntable 150. The turntable 150 is rotatably mounted on the transport carriage 140 and connected to a lever arm 154, which preferably has two cam rollers 156. The guide curve 190 on the mechanical cam plate 180 preferably consists of a closed housing or solid material, with preferably two outer walls running in the transport direction being available for internal guidance of the turntable 150. In such a preferred internal guide, the cam rollers 156 are positioned so that at least one cam roller 156 is in contact with an outer wall of the guide cam 190, preferably at least shortly before the start of the start-up section 162 (not shown in FIG. 5) and shortly after the end of the exit section 164 (not shown in FIG. 5). An external guide for the turntable 150 is also conceivable, in which the guide curve 190 does not consist of a closed housing or solid material, e.g., in an upwardly open U-shape. This provides internal surfaces along which cam rollers 156 can travel. Combinations of the described guide types are also conceivable.

FIG. 6 shows the vacuum supply to the suction cups 152. The suction cups 152 are supplied via a control valve 210 connected to a vacuum source (not shown in FIG. 6). The control valve 210 also has a vacuum rail 212 with several slot-shaped supply holes 220 located at the top, whereby the supply holes 220 are connected to the control valve 210. The vacuum rail 212 is located below the toothed belt 230. The toothed belt 230 has a flattened area 240 with suction holes 250. Each suction hole 250 is connected to a passage in a vacuum cam 260. The vacuum cam 260 is a projection attached to the top of the toothed belt 230 or formed by the belt itself. The vacuum cam 260 has a recess into which a carriage axle 142 extends and is secured in this position in the vacuum cam, the recess being connected at the same time to a suction hole 250. This creates a continuous air channel from the suction hole 250 to the interior of the carriage axle 142, which is designed as a hollow shaft.

During operation, the toothed belt 230 is guided tightly over the vacuum rail 212 in such a way that the suction hole 250 is located at least temporarily over the supply holes 220, creating a continuous air channel from the suction cup 152 to the control valve 210. The air channel can be divided into two parts: in the stationary part of the device 100, it runs from the vacuum source through the control valve 210 and further through the slot-shaped supply holes 220 in the vacuum rail 212. In the subsystem that moves linearly via the vacuum rail 212, it runs through the suction hole 250 in the flattened part of the toothed belt 230, the vacuum cam 260, and the corresponding hollow slide axle 142 of the transport slide 140 to the suction cup 152. If, during operation, the suction hole 250 is located above a supply hole 220, the two air channels described form a single continuous air channel.

In this way, the suction cups 152 can be supplied with negative pressure in a targeted manner on the processing section 160. The shipping bag 110 (not shown in FIG. 6) can thus be securely fixed on the turntable 150 and, if necessary, the fixation can be released again. In the simplest case, the fixation can be released by removing the supply hole 220, thereby preventing the formation of a continuous air channel for supplying the suction cups 152. This may be the case in particular at the end of the processing section 160. However, the strength of the fixation can also be regulated or the fixation can be completely released by specifically reducing the negative pressure applied to the corresponding supply holes 220 via control valve 210.

### List of Reference Symbols

100 Device
110 Shipping bag
120 Mechanical drive
130 Transport track
140 Transport carriage
142 Carriage axle
144 Linear joint
150 Turntable
152 Suction cup
154 Lever arm
156 Cam roller
160 Processing section
162 Start-up section
164 Exit section
170 Return section
180 Cam plate
190 Guide curve
200 Means for supplying negative pressure
210 Control valve
212 Vacuum rail
220 Supply hole
230 Toothed belt
240 Flattened area
250 Suction holes
260 Vacuum cams
270 Air duct
300 Method

1. A device for rotating a shipping bags through a predetermined angle of rotation while the shipping bag is being moved forward on a processing section, comprising:
1.1. a mechanical drive wherein the mechanical drive drives a circulating transport track;
1.2 a transport carriage,
1.2.1 wherein the transport carriage has at least two carriage axles and is mechanically connected to the transport track;
1.3 a turntable,
1.3.1 wherein the turntable is rotatably arranged on the transport carriage;
1.3.2 a suction cup, wherein the suction cup is designed to fix the shipping bag on the turntable;
1.4 means for supplying negative pressure, wherein the means for supplying negative pressure are designed to supply the suction cup with negative pressure;
1.5 a processing section, wherein the shipping bag fixed on the turntable is moved in a transport direction on the processing section and rotated in the process from an initial angular position;
1.6 a return section, wherein the turntable is moved on the return section in an opposite direction to the transport direction and is thereby rotated back to the initial angular position;
1.7 a mechanical cam plate,
1.7.1 wherein the mechanical cam plate has a guide curve; and
1.7.2 the turntable is guided by the guide curve of the mechanical cam plate; and
1.7.3 wherein the mechanical cam plate is designed to cause a rotational movement of the turntable in the specified direction of rotation when passing through the processing section; and
1.8 wherein the mechanical cam plate is designed to cause the turntable to rotate back to its initial angular position when passing through the return path; and
1.9 wherein the rotation of the shipping bag during passage through the processing section and the return section takes place parallel to the transport track about an axis of rotation perpendicular to the transport direction.

2. The device according to claim 1, further comprising:
a start-up section before the start of the processing section as seen in the transport direction and an exit section after the end of the processing section as seen in the transport direction,
wherein the start-up section and the exit section are arranged such that the end of the start-up or exit section facing away from the processing section is at a lower height than the end facing the processing section.

3. The device according to claim 1,
wherein the carriage axles are connected to each other via at least one linear joint or via at least one rigid axis mounted in a sliding manner in such a way that the distance between the carriage axles is variable.

4. The device according to claim 1,
wherein the transport carriage has at least one lever arm; and
wherein the lever arm comprises at least one cam roller designed to be guided along the guide curve of the mechanical cam plate.

5. The device according to claim 1,
wherein the angle of rotation corresponds to an angle enclosed by two adjacent sides of the shipping bag.

6. The device according to claim 1,
wherein the device has an upper guide and wherein the upper guide has a surface parallel to the processing section which is positioned such that a shipping bag moving underneath it comes into contact with the parallel surface as soon as the shipping bag bulges.

7. The device according to claim 1,
wherein the mechanical drive is a toothed belt drive and the device has means for supplying negative pressure, and wherein the means for supplying negative pressure has the following components:
a toothed belt, wherein the toothed belt has a flattened area and wherein the flattened area has at least one suction hole; and
a vacuum source;
a control valve, wherein the control valve is connected to the vacuum source;
a vacuum rail, wherein the vacuum rail has at least one supply hole, and wherein the supply hole is connected to the control valve; and
wherein the toothed belt is guided over the vacuum rail in such a way that the suction hole is temporarily located above the supply hole of the vacuum rail.

8. The device according to claim 7, wherein
the device has a vacuum cam on at least one slide axis of the transport carriage, wherein the vacuum cam has a passage for negative pressure and is connected to a suction hole; and
wherein a continuous air channel is formed from the control valve to the suction cup when the suction hole is located above the supply hole.

9. A method for rotating a shipping bag through a predetermined angle of rotation while the shipping bag is moved forward in a transport direction on a circulating transport track, comprising:
9.1 fixing the shipping bag on a turntable of a transport carriage via negative pressure;
9.2 moving the transport carriage through the processing section
9.3 rotating the shipping bag during passage parallel to the transport track by a predetermined angle of rotation about an axis of rotation perpendicular to the transport direction; and
9.4 rotating the turntable back to an initial angular position when passing through a return section, wherein the initial angular position corresponds to the orientation of the turntable that existed before the rotation in step 9.3.
